(19) United States
(12) Patent Application Publication
(10) Pub. No.: US 2026/0166797 A1
(43) Pub. Date: Jun. 18, 2026

(54) METHOD FOR PREPARING MASTERBATCH FOR HOLLOW POLYPROPYLENE PLATE USING COMPOSITE MODIFICATION OF DOLOMITE

(71) Applicant: Guangxi Academy of Sciences, Guangxi (CN)

(72) Inventors: Zhimin HUANG, Guangxi (CN); Zhonglin LIU, Guangxi (CN); Yanming LI, Guangxi (CN); Zhongjie ZHENG, Guangxi (CN); Wanyu LIU, Guangxi (CN); Min MO, Guangxi (CN)

(21) Appl. No.: 19/530,590

(22) Filed: Feb. 5, 2026

Related U.S. Application Data
(63) Continuation of application No. PCT/CN2025/110887, filed on Jul. 28, 2025.

(30) Foreign Application Priority Data
Nov. 27, 2024 (CN) 202411711412.6

(51) Int. Cl. B29C 48/00; C08L 23/0869; C08L 23/10; C08L 23/12; C08L 23/14; C08L 23/16

(52) U.S. Cl. CPC B29C 48/022; C08L 23/0869; C08L 23/10; C08L 23/12; C08L 23/14; C08L 23/16; C08L 2205/02

(57) ABSTRACT

Provided is a method for preparing a masterbatch for a hollow polypropylene plate using composite modification of a dolomite. The masterbatch is prepared from components including, in parts by weight: 8 parts to 58 parts of the dolomite, 8 parts to 58 parts of calcium carbonate, 30 parts to 60 parts of polypropylene, 0.2 parts to 1.0 part of a coupling agent, and 0.2 parts to 1.0 part of a lubricant, where the polypropylene is a copolymerized polypropylene and a homopolymerized polypropylene.

### CROSS-REFERENCE TO RELATED APPLICATION

The present application is a Continuation of International Patent Application No. PCT/CN2025/110887, filed on Jul. 28, 2025, which claims priority of the Chinese Patent Application No. CN202411711412.6, filed with the China National Intellectual Property Administration (CNIPA) on Nov. 27, 2024 and entitled “METHOD FOR PREPARING MASTERBATCH FOR HOLLOW POLYPROPYLENE PLATE USING COMPOSITE MODIFICATION OF DOLOMITE”. The disclosure of the two applications is incorporated herein by reference in its entirety.

### TECHNICAL FIELD

The present disclosure relates to the technical field of polymer material processing and the field of preparation of hollow polypropylene plates, and in particular to a method for preparing a masterbatch for a hollow polypropylene plate using composite modification of a dolomite.

### BACKGROUND

This section provides only background information relevant to the present disclosure, which is not necessarily the prior art.

Polypropylene (PP) is the most widely used polyolefin and one of the fastest-growing commodity plastics. The PP has good chemical resistance, heat resistance and fatigue resistance, along with properties such as semi-rigidity, translucency, toughness and overall hinge performance. However, an application scope of the PP in engineering thermoplastics is severely limited by high flammability, low-temperature brittleness, and reduced stiffness at low temperatures of the PP. In addition, the PP is inherently non-polar, and is thus not very compatible with almost all polar fillers and reinforcing materials used in the polymer industry.

One of a primary key challenges in producing inorganic/organic composite materials with excellent performance is overcoming agglomeration of mineral filler particles in a polypropylene matrix. Preparation steps for a traditional hollow polypropylene plate include preparation of a filler masterbatch, mixing of the filler masterbatch with a polypropylene resin followed by plate extrusion, and cutting of sheets, etc. At present, most inorganic fillers in the filler masterbatch are an unmodified calcium carbonate powder, which significantly reduces toughness of a hollow plate. Compared with calcium carbonate, a dolomite exhibits good toughness and thermal stability, but stiffness of the latter is inferior to that of the former. However, neither the dolomite nor a calcium carbonate powder alone could be well combined with the polypropylene when used as fillers. A hollow polypropylene plate, which is prepared with a single type of mineral powder as a filler, exhibits relatively weak performance, and is thus no longer suitable for rapidly evolving logistics and packaging industry. A hollow polypropylene plate with good aging resistance and a long recycling life will be more favored in the market. In addition, production process, in which the filler masterbatch is prepared first and the filler masterbatch is then mixed with a resin to prepare a hollow plate, is cumbersome, and excessive production procedures may cause higher energy consumption and more waste emission, exacerbating environmental degradation.

Therefore, the present disclosure provides a method for preparing a masterbatch for a hollow polypropylene plate using composite modification of a dolomite. A hollow plate is directly produced by the masterbatch to reduce production steps, and lower energy consumption related to carbon peak and carbon neutrality, thereby improving industrial efficiency while environmental protection is enhanced.

### SUMMARY

Objects of the disclosure: the technical problem to be solved by the present disclosure is to provide a hollow polypropylene plate or a masterbatch for preparing a hollow polypropylene plate, and a preparation method for the hollow polypropylene plate and the masterbatch.

To solve the above technical problem, the present disclosure discloses the following technical solutions.

In a first aspect, the present disclosure discloses a hollow polypropylene plate and a masterbatch for preparing the hollow polypropylene plate, where the hollow polypropylene plate and the masterbatch for preparing the hollow polypropylene plate are prepared from components including, in parts by weight:
8 parts to 58 parts of a dolomite,
8 parts to 58 parts of calcium carbonate,
30 parts to 60 parts of polypropylene,
0.2 parts to 1.0 part of a coupling agent, and
0.2 parts to 1.0 part of a lubricant,
where the polypropylene is a combination of a copolymerized polypropylene and a homopolymerized polypropylene.

In a second aspect, the present disclosure discloses a method for preparing the hollow polypropylene plate and the masterbatch for preparing the hollow polypropylene plate, where the hollow polypropylene plate and the masterbatch for preparing the hollow polypropylene plate are prepared from the components including, in parts by weight:
8 parts to 58 parts of the dolomite,
8 parts to 58 parts of the calcium carbonate,
30 parts to 60 parts of the polypropylene,
0.2 parts to 1.0 part of the coupling agent, and
0.2 parts to 1.0 part of the lubricant,
where the polypropylene is the combination of the copolymerized polypropylene and the homopolymerized polypropylene.

In the first aspect and the second aspect:

The copolymerized polypropylene in the present disclosure has a molecular weight of 50,000-500,000, for example, 80,000-150,000, and a melt index of 1.8-2.7 g/10 minutes, for example, 2-2.5 g/10 minutes, for example, a copolymerized polypropylene of China Petroleum and Chemical Corporation Limited (model: K8003, molecular weight: 50,000-500,000, and melt index: 2.5 g/10 minutes), and a copolymerized polypropylene of Sinopec Maoming Petrochemical Co., Ltd., China (model: M02D, molecular weight: 80,000-150,000, and melt index: 1.8 g/10 minutes).

The homopolymerized polypropylene in the present disclosure has a molecular weight of 80,000-150,000 and a melt index of 0.5-4 g/10 minutes, for example, 3.0 g/10 minutes, for example, a homopolymerized polypropylene of China Energy Investment Corporation Co., Ltd. (model: 1102K, molecular weight: 80,000-150,000, and melt index: 3.0 g/10 minutes), and a homopolymerized polypropylene of Formosa Plastics Corporation, China (model: 1005N, molecular weight: 80,000-150,000, and melt index: 0.5 g/10 minutes).

In some embodiments, the components are in the following parts by weight:
10 parts to 53 parts of the dolomite,
10 parts to 53 parts of the calcium carbonate,
35 parts to 50 parts of the polypropylene,
0.4 parts to 0.8 parts of the coupling agent, and
0.4 parts to 0.8 parts of the lubricant.

In some embodiments, the components are in the following parts by weight:
12 parts to 48 parts of the dolomite,
12 parts to 48 parts of the calcium carbonate,
40 parts of the polypropylene;
0.6 parts of the coupling agent, and
0.6 parts of the lubricant.

In some embodiments, a mass ratio of the copolymerized polypropylene to the homopolymerized polypropylene is in a range of 0.1-5.2:1. In some embodiments, the mass ratio is in a range of 0.2-4.7:1. In some embodiments, the mass ratio is 7:33, 13:27, 20:20, 27:13 or 33:7.

In some embodiments, the dolomite and the calcium carbonate each are fine powder sieved through a sieve with 800 meshes to 1,500 meshes, for example, through a sieve with 1,250 meshes. In some embodiments, the dolomite and the calcium carbonate may be pulverized via jet milling.

In some embodiments, the coupling agent is at least one selected from the group consisting of an aluminate coupling agent, and a titanate coupling agent; and in some embodiments, the aluminate coupling agent is an aluminate coupling agent DL-411, and the titanate coupling agent is a titanate coupling agent NDZ-201.

In some embodiments, the lubricant is at least one selected from the group consisting of stearic acid, and zinc stearate.

In some embodiments, the method comprises the following steps:
(1) pre-mixing the dolomite and the calcium carbonate, and adding the coupling agent, the lubricant and the polypropylene and then mixing, so as to obtain a mixture;
(2) plasticizing the mixture in an internal mixer to obtain a mixture melt;
(3) plasticizing and granulating the mixture melt in a twin-screw extruder to obtain the masterbatch for the hollow polypropylene plate; and
(4) subjecting the masterbatch for the hollow polypropylene plate to compression molding by a thermocompressor to obtain a sheet, and placing the sheet in a cool place to obtain the hollow polypropylene plate, where the hollow polypropylene plate is prepared with raw material being a dolomite composite-modified powder and has excellent aging resistance; or putting the masterbatch for the hollow polypropylene plate into a hollow plate extruder to obtain the hollow polypropylene plate, where the hollow polypropylene plate is prepared with raw material being a dolomite composite-modified powder and has excellent aging resistance.

In some embodiments, in step (1), the dolomite and the calcium carbonate are put into a high-speed mixer, a speed of the high-speed mixer is regulated to 600-800 r/minute, and then pre-mixing is conducted at a temperature of 115-135° C. for 10 minutes to 20 minutes. The coupling agent is added first and then pre-mixed for 2 minutes to 10 minutes, the lubricant is then added and pre-mixed for 2 minutes to 8 minutes, and subsequently, the polypropylene is added and then mixed for 4 minutes to 12 minutes to obtain the mixture.

In some embodiments, in step (2), the plasticizing is performed at a temperature of 180-220° C., and preferably 190-210° C. In some embodiments, the plasticizing is performed at a rotation rate of 400-600 r/minute.

In some embodiments, in step (3), a temperature of the twin-screw extruder is in intervals of 180-190° C., 185-195° C., 190-200° C., 195-205° C., 200-210° C., 205-215° C., 210-220° C., 210-220° C. and 205-215° C., and preferably 185° C., 190° C., 195° C., 200° C., 205° C., 210° C., 215° C., 215° C. and 210° C. In some embodiments, the twin-screw extruder is at a rate of 150-170 rpm, with a flow rate of the mixture melt being 50-60 L/minute, and an air-cooled hot cut frequency being 4-6 Hz.

Separately modifying a calcium carbonate powder and a dolomite powder makes it difficult to leverage their respective characteristic advantages. With respect to a dolomite and calcium carbonate composite-modified powder, in view of characteristics and properties of a dolomite material, i.e. good heat resistance and high toughness, the present disclosure provides a method for preparing a hollow polypropylene plate with a dolomite modified raw material, in which a feedstock is prepared through different pretreatment based on structure, morphology and ultra-refinement. The method of the present disclosure is capable of replacing the conventional method including first preparing a filler masterbatch with an untreated calcium carbonate powder and then adding polypropylene to prepare the hollow polypropylene plate.

By the method provided in the present disclosure, a problem of a traditional hollow polypropylene plate having poor aging resistance performance is ameliorated, operation flows in processing are reduced, and an added value of a dolomite is also increased, thereby reducing a manufacturing cost of the hollow polypropylene plate. When only a small amount of the polypropylene, the dolomite and calcium carbonate are used as composite material modified fillers for loading, a result shows that a synergistic hybrid effect is successfully achieved by composite modification of the dolomite, the polypropylene and the calcium carbonate. Mechanical properties demonstrate higher tensile strength and elongation at break, and the toughness and aging resistance performance of the hollow polypropylene plate are also significantly improved to achieve a toughening and strengthening effect, thereby enabling long-term durability of the hollow polypropylene plate.

The present disclosure shows outstanding advantages as follows. (1) In view of properties and characteristics of the dolomite, a composite-modified inorganic powder raw material is obtained by partially replacing calcium carbonate inorganic fillers with the dolomite and performing mixing and modification to prepare the hollow polypropylene plate, where the hollow polypropylene plate may be used for building materials. Preparation of a feedstock effectively reduces processing steps, improves production efficiency, and lowers the manufacturing cost of the hollow polypropylene plate. (2) With fewer fillers, modified dolomite particles exhibit better dispersion performance. On one hand, an ultra-refined dolomite powder as a solid solution could toughen and strengthen a modified composite powder; on the other hand, the dolomite and the calcium carbonate are similar in structure and composition. After blending, due to the principle of like dissolves like, the intermolecular bonding force between the dolomite and the calcium carbonate remains strong, which is macroscopically embodied as a composite powder retaining excellent mechanical properties. (3) A formulation is optimized. When the dolomite powder and the calcium carbonate powder are mixed for composite modification, the hollow polypropylene plate exhibits significantly improved aging resistance performance. Elongation at break is one of important indicators for measuring ductility or toughness of a material. Compared with the traditional hollow polypropylene plate prepared solely with the calcium carbonate powder, the hollow polypropylene plate prepared with a composite modified powder containing the dolomite has better elongation at break. When a small amount of the dolomite and the calcium carbonate are used as composite material modified fillers, a result shows that a synergistic hybrid effect is successfully achieved by a dolomite composite-modified powder.

### Beneficial Effects

The present disclosure makes full use of advantages of a dolomite, i.e. good heat resistance and high toughness, partially replacing calcium carbonate with the dolomite and performing blending for composite modification to prepare a hollow polypropylene plate, thereby reducing a preparation cost, and thus effectively prolonging a service life of the hollow polypropylene plate and increasing an added value thereof.

By the method provided in the present disclosure, after blending, elongation at break of the hollow polypropylene plate is increased while a production cost thereof is reduced, and aging resistance is also improved.

By the method provided in the present disclosure, a hollow plate is prepared in a production manner in which a powder polypropylene feedstock is modified with the dolomite, which improves the current domestic method of preparing a filler masterbatch first and then adding polypropylene, reducing production steps.

### DETAILED DESCRIPTION OF THE EMBODIMENTS

The present disclosure could be better understood in view of the following embodiments. However, as can be readily understood by a person skilled in the art, contents described in the embodiments are only used for describing the present disclosure and should not and could not limit the present disclosure described in claims in detail.

Unless otherwise specified, all experimental methods in the following examples are conventional, and all reagents and materials can be found commercially.

In the following examples, a copolymerized polypropylene (models: K8003 and M02D) is sourced from China Petroleum and Chemical Corporation Limited, a homopolymerized polypropylene (models: 1102K and 1005N) is sourced from China Energy Investment Corporation Co., Ltd. and Formosa Plastics Corporation, China, and stearic acid (model: 1840), zinc stearate (CAS No.: 557-05-1) and a coupling agent (model: DL-411) are sourced from Dongguan Dinghai Plastic Chemical Co., Ltd., China.

In the following examples, mechanical properties are tested using standard specimen bars in accordance with national standards. Tensile and bending properties of a composite material specimen bar are tested by an electronic universal mechanical tester, and an impact property is tested by a cantilever beam impact tester.

Tensile property test: according to a GB/T1040.2-2006 standard, a specimen is a dumbbell-shaped specimen with dimensions of 170 mm*20 mm*4 mm, a narrow section width of 10 mm, and a preferred thickness of 4 mm. A gauge length used for measurement is 50 mm, and a test speed is 50 mm/minute.

Bending property test: according to a GB/T9341-2008 standard, a specimen has dimensions of 80 mm*10 mm*4 mm, with a support span of 64 mm for testing and a test speed of 2 mm/minute.

Impact property test: according to a GB/T1843-2008 standard, a notched impact mode is used, and a specimen has dimensions of 80 mm*10 mm*4 mm, with an impact energy of 5.5 J and an impact speed of 2.9 m/s.

Aging property test: according to a GB/T16422.3-2022 standard, a specimen has dimensions of 80 mm*10 mm*4 mm, a UVA-351 (Type 1B) test chamber is used, with an uniform irradiance set as 0.76 W/(m²·nm) at 340 nm, and an aging period is 28 days at 50° C.

In the following examples, unless otherwise specified, all parts are by weight.

### Example 1 A Hollow Polypropylene Plate Prepared with a Composite Modified Raw Material Containing a Dolomite

(1) First, the dolomite and calcium carbonate were pulverized into a 1,250-mesh ultrafine powder using jet milling, respectively. Then, 48 parts by weight of the 1,250-mesh ultrafine powder of the calcium carbonate and 12 parts by weight of the 1,250-mesh ultrafine powder of the dolomite were put into a high-speed mixer and then high-speed pre-mixed with a speed regulated to 700 r/minute, and pretreated for 15 minutes under a constant temperature condition of 125° C. Afterwards, 0.6 parts by weight of an aluminate coupling agent (model: DL-411) was added and then pre-mixed for 5 minutes, and 0.3 parts by weight of stearic acid and 0.3 parts by weight of zinc stearate were then added and then pre-mixed for 5 minutes. Subsequently, a mixed raw material of 7 parts by weight of a copolymerized polypropylene (K8003) and 33 parts by weight of a homopolymerized polypropylene (1102K) was added and then blended for 8 minutes to obtain a uniform mixture.

(2) The uniform mixture was transferred to a low-speed mixer and then fed into a continuous internal mixer at a feeding speed of 8 r/minute. The uniform mixture was plasticized under a condition of a rotation rate of 500 r/minute and a melting temperature of 200° C. to obtain a mixture melt.

(3) The mixture melt was fed into a twin-screw extruder through a forced feeder and then re-plasticized and granulated, with extrusion conditions of: temperature intervals: 185° C., 190° C., 195° C., 200° C., 205° C., 210° C., 215° C., 215° C. and 210° C.; an extrusion speed: 160 rpm; a flow rate of the mixture melt: 55 L/minute; and an air-cooled hot cut frequency: 5.0 Hz, to obtain a masterbatch for a hollow plate, the masterbatch was dried and then injection-molded into a standard specimen bar, and the standard specimen bar was subjected to testing.

### Example 2

Example 2 was the same as Example 1, except that the copolymerized polypropylene (K8003) and the homopolymerized polypropylene (1102K) were replaced with a copolymerized polypropylene (M02D) and a homopolymerized polypropylene (1005N).

### COMPARATIVE EXAMPLES

Comparative Examples were the same as Example 1, except that amounts of components in step (1) were different, specifically as follows.

TABLE 1
Amounts of components in Example 1 and Comparative Examples

| | | Dolo- | | |
|---|---|---|---|---|
| | Calcium | mite | Copolymerized | Homopolymerized |
| | carbonate | (12 | polypropylene | polypropylene |
| Example 1 | (48 parts) | parts) | (7 parts) | (3 parts) |
| Comparative | 60 parts | 0 | 40 parts | 0 |
| Example 1-1 | | | | |
| Comparative | 60 parts | 0 | 0 | 40 parts |
| Example 1-2 | | | | |
| Comparative | 0 | 60 parts | 40 parts | 0 |
| Example 1-3 | | | | |
| Comparative | 0 | 60 parts | 0 | 40 parts |
| Example 1-4 | | | | |
| Comparative | 48 parts | 12 parts | 40 parts | 0 |
| Example 1-5 | | | | |
| Comparative | 48 parts | 12 parts | 0 | 40 parts |
| Example 1-6 | | | | |

The hollow polypropylene plates prepared by the above methods were tested, and results are as follows.

TABLE 2
Testing results of hollow polypropylene plates in Examples and Comparative Examples

| | | Example | Example | Comparative Example | | | | | |
|---|---|---|---|---|---|---|---|---|---|
| Test item | | 1 | 2 | 1-1 | 1-2 | 1-3 | 1-4 | 1-5 | 1-6 |
| Tensile | Strength (MPa) | 19.16 | 18.39 | 16.34 | 15.41 | 15.09 | 15.43 | 15.89 | 16.21 |
| | Maximal force | 726.45 | 693.45 | 611.49 | 606.41 | 622.64 | 583.34 | 617.62 | 626.45 |
| | (N) | | | | | | | | |
| | Elongation at | 260.61 | 206.93 | 183.40 | 174.43 | 152.48 | 113.46 | 162.40 | 149.48 |
| | break (%) | | | | | | | | |
| Bending | Strength (MPa) | 31.55 | 30.71 | 28.92 | 26.96 | 29.44 | 24.41 | 25.07 | 28.52 |
| | Modulus (MPa) | 4155.30 | 4107.23 | 3470.23 | 3618.41 | 3365.79 | 3761.18 | 3665.79 | 3840.23 |

| | | | | | | | | |
|---|---|---|---|---|---|---|---|---|
| Impact strength (KJ/m²) | 7.43 | 6.69 | 4.19 | 3.74 | 4.25 | 4.18 | 4.66 | 4.23 |

The hollow polypropylene plates prepared by the above methods were tested after aging, and results are as follows.

Aging condition: UV aging for 28 days at 50° C.

TABLE 3
Testing results of hollow polypropylene plates in
Examples and Comparative Examples after aging

| | | Example | Example | Comparative Example | | | | | |
|---|---|---|---|---|---|---|---|---|---|
| Test item | | 1 | 2 | 1-1 | 1-2 | 1-3 | 1-4 | 1-5 | 1-6 |
| Tensile | Strength | 15.87 | 15.02 | 10.56 | 9.14 | 11.14 | 10.29 | 12.22 | 11.27 |
| | (MPa) | | | | | | | | |
| | Maximal | 667.21 | 631.77 | 536.52 | 521.64 | 533.41 | 498.72 | 487.63 | 517.82 |
| | force (N) | | | | | | | | |
| | Elongation | 231.82 | 182.63 | 157.23 | 132.98 | 127.76 | 99.61 | 129.91 | 122.73 |
| | at break | | | | | | | | |
| | (%) | | | | | | | | |
| Bending | Strength | 28.56 | 26.84 | 19.29 | 20.66 | 23.26 | 21.29 | 21.05 | 20.02 |
| | (MPa) | | | | | | | | |
| | Modulus | 3695.37 | 3534.61 | 2606.98 | 2898.21 | 2597.64 | 3006.19 | 3053.51 | 3112.10 |
| | (MPa) | | | | | | | | |

| | | | | | | | | |
|---|---|---|---|---|---|---|---|---|
| Impact strength | 6.36 | 5.94 | 3.02 | 2.89 | 3.48 | 3.11 | 3.39 | 3.41 |
| (KJ/m²) | | | | | | | | |

It can be seen that composite modification of two types of inorganic mineral powder with similar compositions in the present disclosure, using a dolomite as a reinforcing aggregate, improves bonding performance between polypropylene and fillers to a certain extent, thereby further improving aging resistance of the hollow polypropylene plate.

### Example 3

Example 3 was the same as Example 1, except that amounts of a copolymerized polypropylene and a homopolymerized polypropylene were changed, with results as follows.

TABLE 4
Testing results of hollow polypropylene plates obtained with different amounts
of copolymerized polypropylene and homopolymerized polypropylene

| | | 7 parts of | | | | |
|---|---|---|---|---|---|---|
| | | copolymerized | 13 parts of | 20 parts of | 27 parts of | 33 parts of |
| | | polypropylene:33 | copolymerized | copolymerized | copolymerized | copolymerized |
| | | parts of | polypropylene:27 | polypropylene:20 | polypropylene:13 | polypropylene:7 |
| | | homopolymerized | parts of | parts of | parts of | parts of |
| | | polypropylene | homopolymerized | homopolymerized | homopolymerized | homopolymerized |
| Test item | | (Example 1) | polypropylene | polypropylene | polypropylene | polypropylene |
| Tensile | Strength | 19.16 | 18.14 | 17.84 | 16.83 | 15.76 |
| | (MPa) | | | | | |
| | Maximal | 726.45 | 697.45 | 645.64 | 593.23 | 550.53 |
| | force (N) | | | | | |
| | Elongation | 260.61 | 266.64 | 270.31 | 108.92 | 98.92 |
| | at break | | | | | |
| | (%) | | | | | |
| Bending | Strength | 31.55 | 32.69 | 29.81 | 27.61 | 24.98 |
| | (MPa) | | | | | |
| | Modulus | 4155.30 | 3405.23 | 3185.68 | 2968.56 | 2586.73 |
| | (MPa) | | | | | |

| | | | | | |
|---|---|---|---|---|---|
| Impact strength | 7.43 | 9.31 | 14.54 | 18.23 | 21.87 |
| (KJ/m²) | | | | | |

### Example 4

Example 4 was the same as Example 1, except that amounts of calcium carbonate and a dolomite were changed, with results as follows.

TABLE 5
Testing results of hollow polypropylene plates obtained
with different amounts of calcium carbonate and dolomite

| | | 48 parts of | 36 parts of | 24 parts of | 12 parts of |
|---|---|---|---|---|---|
| | | calcium | calcium | calcium | calcium |
| | | carbonate:12 | carbonate:24 | carbonate:36 | carbonate:48 |
| | | parts of dolomite | parts of | parts of | parts of |
| Test item | | (Example 1) | dolomite | dolomite | dolomite |
| Tensile | Strength | 19.16 | 17.34 | 16.28 | 15.47 |
| | (MPa) | | | | |
| | Maximal | 726.45 | 685.77 | 671.14 | 668.61 |
| | force (N) | | | | |
| | Elongation at | 260.61 | 170.23 | 151.04 | 132.99 |
| | break (%) | | | | |
| Bending | Strength | 31.55 | 30.88 | 30.98 | 31.75 |
| | (MPa) | | | | |
| | Modulus | 4155.30 | 5130.54 | 4865.80 | 3999.87 |
| | (MPa) | | | | |

| | | | | |
|---|---|---|---|---|
| Impact strength (KJ/m²) | 7.43 | 6.88 | 6.92 | 7.21 |

The above descriptions are merely preferred embodiments of the present disclosure and do not impose any formal limitations thereon. It should be noted that, a person of ordinary skill in the art may further make various improvements and modifications without departing from the principle of the present disclosure, but such improvements and modifications should also be deemed as falling within the scope of the present disclosure.

What is claimed is:

1. A method for preparing a hollow polypropylene plate or a masterbatch for a hollow polypropylene plate, wherein the hollow polypropylene plate or the masterbatch for the hollow polypropylene plate is prepared from components comprising, in parts by weight:
8 parts to 58 parts of a dolomite,
8 parts to 58 parts of calcium carbonate,
30 parts to 60 parts of polypropylene,
0.2 parts to 1.0 part of a coupling agent, and
0.2 parts to 1.0 part of a lubricant,
wherein the polypropylene is a combination of a copolymerized polypropylene and a homopolymerized polypropylene.

2. The method of claim 1, wherein the components are in the following parts by weight:
10 parts to 53 parts of the dolomite,
10 parts to 53 parts of the calcium carbonate,
35 parts to 50 parts of the polypropylene,
0.4 parts to 0.8 parts of the coupling agent, and
0.4 parts to 0.8 parts of the lubricant.

3. The method of claim 1, wherein the components are in the following parts by weight:
12 parts to 48 parts of the dolomite,
12 parts to 48 parts of the calcium carbonate,
40 parts of the polypropylene,
0.6 parts of the coupling agent, and
0.6 parts of the lubricant.

4. The method of claim 1, wherein the components are in the following parts by weight:
12 parts of the dolomite,
48 parts of the calcium carbonate,
40 parts of the polypropylene,
0.6 parts of the coupling agent, and
0.6 parts of the lubricant;
alternatively, the components are in the following parts by weight:
48 parts of the dolomite,
12 parts of the calcium carbonate,
40 parts of the polypropylene,
0.6 parts of the coupling agent; and
0.6 parts of the lubricant;
alternatively, the components are in the following parts by weight:
36 parts of the dolomite,
24 parts of the calcium carbonate,
40 parts of the polypropylene,
0.6 parts of the coupling agent, and
0.6 parts of the lubricant; and
alternatively, the components are in the following parts by weight:
24 parts of the dolomite,
36 parts of the calcium carbonate,
40 parts of the polypropylene,
0.6 parts of the coupling agent, and
0.6 parts of the lubricant.

5. The method of claim 1, wherein a mass ratio of the copolymerized polypropylene to the homopolymerized polypropylene is in a range of 0.1-5.2:1.

6. The method of claim 1, wherein the copolymerized polypropylene has a melt index of 1.8-2.7 g/10 minutes.

7. The method of claim 1, wherein the homopolymerized polypropylene has a melt index of 0.5-4 g/10 minutes.

8. The method of claim 1, wherein the dolomite and the calcium carbonate each are fine powder sieved through a sieve with 800 meshes to 1,500 meshes.

9. The method of claim 8, wherein the dolomite and the calcium carbonate each are fine powder sieved through a sieve with 1,250 meshes.

10. The method of claim 1, wherein the coupling agent is at least one selected from the group consisting of an aluminate coupling agent, and a titanate coupling agent; and
the lubricant is at least one selected from the group consisting of stearic acid, and zinc stearate.

11. The method of claim 10, wherein the aluminate coupling agent is an aluminate coupling agent DL-411, and the titanate coupling agent is a titanate coupling agent NDZ-201.

12. The method of claim 1, wherein the method for preparing the masterbatch comprises the following steps:
(1) pre-mixing the dolomite and the calcium carbonate, and adding the coupling agent, the lubricant and the polypropylene and then mixing, so as to obtain a mixture;
(2) plasticizing the mixture in an internal mixer to obtain a mixture melt; and
(3) plasticizing and granulating the mixture melt in a twin-screw extruder to obtain the masterbatch.

13. The method of claim 12, wherein step (1) is performed by: pre-mixing the dolomite and the calcium carbonate for 10 minutes to 20 minutes, adding the coupling agent first and then pre-mixing for 2 minutes to 10 minutes, then adding the lubricant and then pre-mixing for 2 minutes to 8 minutes, and subsequently, adding the polypropylene and then mixing for 4 minutes to 12 minutes to obtain the mixture.

14. The method of claim 13, wherein the pre-mixing the dolomite and the calcium carbonate for 10 minutes to 20 minutes in the step (1) is performed by: putting the dolomite and the calcium carbonate into a high-speed mixer, regulating a speed of the high-speed mixer to 600-800 r/minute, and pre-mixing at a temperature of 115-135° C. for 10 minutes to 20 minutes.

15. The method of claim 12, wherein in step (2), the plasticizing is performed at a temperature of 180-220° C.

16. The method of claim 15, wherein in the step (2), the plasticizing is performed at the temperature of 190-210° C.

17. The method of claim 12, wherein in step (2), the plasticizing is performed at a rotation rate of 400-600 r/minute.

18. The method of claim 12, wherein in step (3), a temperature of the twin-screw extruder is in intervals of 180-190° C., 185-195° C., 190-200° C., 195-205° C., 200-210° C., 205-215° C., 210-220° C., 210-220° C. and 205-215° C.

19. The method of claim 18, wherein in the step (3), the temperature of the twin-screw extruder is in intervals of 185° C., 190° C., 195° C., 200° C., 205° C., 210° C., 215° C., 215° C. and 210° C.

20. The method of claim 12, wherein in step (3), the twin-screw extruder is at a rate of 150-170 rpm, with a flow rate of the mixture melt being 50-60 L/minute and an air-cooled hot cut frequency being 4-6 Hz.
